(19) United States
(12) Patent Application Publication
(10) Pub. No.: US 2016/0301588 A1
(43) Pub. Date: Oct. 13, 2016

(54) SYSTEM AND METHOD FOR TESTING WIRELESS DATA PACKET SIGNAL TRANSCEIVER

(71) Applicant: Litepoint Corporation, Sunnyvale, CA (US)

(72) Inventors: Christian Volf OLGAARD, Saratoga, CA (US); Ruizu Wang, San Ramon, CA (US)

(21) Appl. No.: 14/685,120

(22) Filed: Apr. 13, 2015

(51) Int. Cl. H04L 12/26; H04B 17/15

(52) U.S. Cl. CPC H04L 43/0847; H04B 17/15

(57) ABSTRACT

System and method for testing a radio frequency (RF) data packet signal transceiver device under test (DUT) to enable use of measured packet error rate (PER) to determine transmit signal quality and thereby estimate error vector magnitude (EVM) of the DUT. By using a reference RF data packet signal transceiver having device characteristics and capabilities similar to the DUT including a low noise figure, in place of a formal test instrument with a significantly higher noise figure, significantly lower power DUT transmit signals can be tested, since the additional SNR is not required to determine transmit signal quality, thereby enabling reliable testing of transmit signal quality of the lower power signals from the DUTs. With a calibrated reference RF data packet signal receiver, a reduction in sensitivity as compared to the calibrated sensitivity indicates a reduced transmit signal quality of the received packet.

### BACKGROUND

The present invention relates to testing of a radio frequency (RF) data packet signal transceiver, and in particular, to measuring transmit signal quality of a RF data packet signal transceiver device under test (DUT) and thereby enabling estimation of its Error Vector Magnitude (EVM).

Many of today's electronic devices use wireless signal technologies for both connectivity and communications purposes. Because wireless devices transmit and receive electromagnetic energy, and because two or more wireless devices have the potential of interfering with the operations of one another by virtue of their signal frequencies and power spectral densities, these devices and their wireless signal technologies must adhere to various wireless signal technology standard specifications.

When designing such wireless devices, engineers take extra care to ensure that such devices will meet or exceed each of their included wireless signal technology prescribed standard-based specifications. Furthermore, when these devices are later being manufactured in quantity, they are tested to ensure that manufacturing defects will not cause improper operation, including their adherence to the included wireless signal technology standard-based specifications.

For testing these devices following their manufacture and assembly, current wireless device test systems typically employ testing subsystems for providing test signals to each device under test (DUT) and analyzing signals received from each DUT. Some subsystems (often referred to as “testers”) include at least a vector signal generator (VSG) for providing the source signals to be transmitted to the DUT, and a vector signal analyzer (VSA) for analyzing signals produced by the DUT. The production of test signals by the VSG and signal analysis performed by the VSA are generally programmable (e.g., through use of an internal programmable controller or an external programmable controller such as a personal computer) so as to allow each to be used for testing a variety of devices for adherence to a variety of wireless signal technology standards with differing frequency ranges, bandwidths and signal modulation characteristics.

As part of the manufacturing of wireless communication devices, one significant component of production cost is costs associated with these manufacturing tests. Typically, there is a direct correlation between the cost of test and the sophistication of the test equipment required to perform the test. Thus, innovations that can preserve test accuracy while minimizing equipment costs (e.g., increasing costs due to increasing sophistication of necessary test equipment, or testers) are important and can provide significant costs savings, particularly in view of the large numbers of such devices being manufactured and tested.

Referring to FIG. 1, one of the tests typically performed that is specified in the applicable standard is described as Error Vector Magnitude (EVM), which is a measure of transmit signal quality and provides an indication of the sum of the effects that various imperfections in the DUT implementation (e.g., due to design or manufacturing) have on the data symbols within the transmitted data packet signal. Typical imperfections are due to signal compression, signal dynamic range, I/Q errors, interference and phase noise. As is well known in the art, EVM is the magnitude of the distance within the signal space between the ideal symbol location and the measured symbol location. The ideal symbol location has an associated magnitude V+E and phase angle θ (theta), while the measured symbol location has a magnitude V and phase angle equal to the sum of θ and a phase error angle.

The EVM specified by the standard will have a not-to-exceed value. Testing EVM is relevant to manufacturing and can be time consuming, especially for lower bit-rate modulation schemes. Further, obtaining accurate EVM measurements requires use of test equipment with a high signal-to-noise ratio (SNR). This makes such measurements in over-the-air (OTA) testing environments particularly difficult since the transmitted signal levels being measured are very low (due to the signal attenuation introduced by the wireless signal path), thereby resulting in measurements of signals with low SNRs. However, EVM measurements are important and are usually performed to verify the modulation accuracy of the OFDM (orthogonal frequency-division multiplexing) transmitter, with EVM providing a simple single number summary of the quality of the signal transmitter.

Referring to FIG. 2 a typical test environment 10 includes the DUT 12 and test equipment in the form of an EVM tester 14, with signal communication occurring via a signal path 16, typically in the form of a wired connection including coaxial cable 16c connected via coaxial connectors 12c, 14c mounted on or otherwise associated with the DUT 12 and tester 14.

When measuring EVM, it is important that the tester 14 performing such a measurements has internal circuitry that performs well enough that its contribution to the measured EVM be significantly less than the EVM contribution due to the performance of the DUT. The general requirement is that the added EVM due to the performance of the tester 14 be at least 10 dB less than the EVM of the signal from the DUT being measured to provide an EVM measurement predominantly indicative of the performance of the DUT. With EVM requirements increasing with numerous standards, this becomes more difficult and more expensive to achieve and maintain.

Further, most measurement instruments are designed to measure signal characteristics at high input signal power levels, with the test instrument typically connected to the DUT through a wired connection with limited signal attenuation. As a result, most instruments have an input noise figure significantly higher than the noise figure of a typical receiver circuit of the DUT. For example, a test instrument can often have a 30 dB noise figure, as compared to a more typical 3-4 dB noise figure of the receiver circuitry of the DUT. This added instrument noise, therefore, limits the minimum signal levels that can be measured, thereby making the test instrument less effective to measure low signal power levels, such as would be expected for a test environment using an OTA signal path, or testing environments where a large signal path loss is experienced otherwise.

### SUMMARY

In accordance with the presently claimed invention, a system and method are provided for testing a radio frequency (RF) data packet signal transceiver device under test (DUT) to enable use of measured packet error rate (PER) to determine transmit signal quality and thereby estimate error vector magnitude (EVM) of the DUT. By using a reference RF data packet signal transceiver having device characteristics and capabilities similar to the DUT, including a low noise figure, in place of a formal test instrument with a significantly higher noise figure, significantly lower power DUT transmit signals can be tested, since the additional SNR is not required to determine transmit signal quality, thereby enabling reliable testing of transmit signal quality of the lower power signals from the DUTs. With a calibrated reference RF data packet signal receiver, a reduction in sensitivity as compared to the calibrated sensitivity indicates a reduced transmit signal quality of the received packet.

In accordance with one embodiment of the presently claimed invention, a system for testing a radio frequency (RF) data packet signal transceiver device under test (DUT), including:

a RF signal path to convey, from a DUT, a transmit data packet signal having a transmit signal power and including a plurality of transmit data packets;

attenuation circuitry coupled to the RF signal path and responsive to one or more control signals by attenuating the transmit data packet signal to provide a corresponding attenuated data packet signal having an attenuated signal power and including the plurality of transmit data packets;

receiver circuitry coupled to the attenuation circuitry and responsive to the attenuated data packet signal by providing a reply data packet signal including a plurality of reply data packets; and

control circuitry coupled to the RF signal path, the attenuation circuitry and the receiver circuitry, and responsive to the transmit and reply data packet signals by providing the one or more control signals such that a ratio of the pluralities of reply and transmit data packets is less than a defined value.

In accordance with another embodiment of the presently claimed invention, a method for testing a radio frequency (RF) data packet signal transceiver device under test (DUT), including:

conveying, from a DUT via a RF signal path, a transmit data packet signal having a transmit signal power and including a plurality of transmit data packets;

responding to one or more control signals by attenuating the transmit data packet signal to provide a corresponding attenuated data packet signal having an attenuated signal power and including the plurality of transmit data packets;

receiving the attenuated data packet signal and in response thereto providing a reply data packet signal including a plurality of reply data packets; and

receiving the transmit and reply data packet signals and in response thereto providing the one or more control signals such that a ratio of the pluralities of reply and transmit data packets is less than a defined value.

### BRIEF DESCRIPTION OF THE DRAWINGS

FIG. 1 depicts EVM schematically for a data packet signal transmitter.

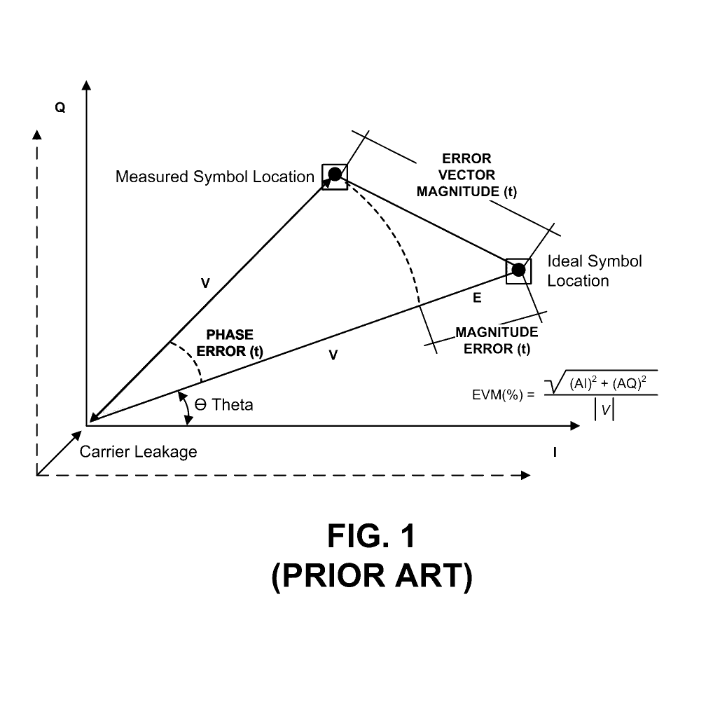

FIG. 2 depicts a test environment for measuring EVM of a DUT.

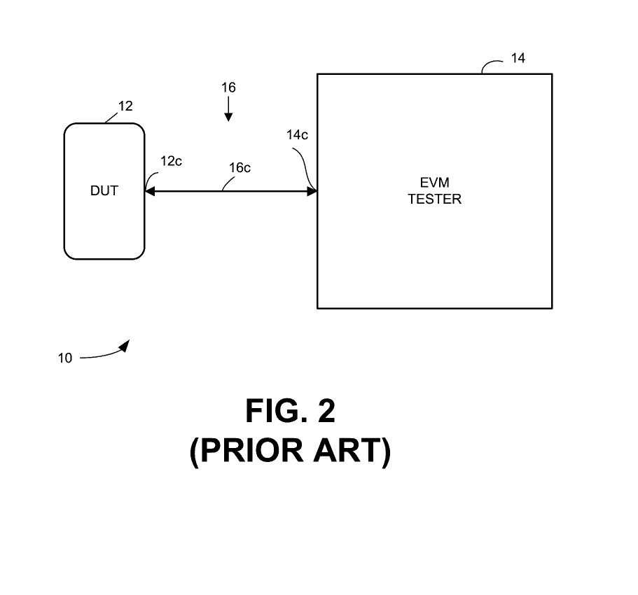

FIG. 3 depicts typical correlation between EVM and packet error rate (PER) of a data packet signal transmitter.

FIG. 4 depicts a test environment for establishing a PER to estimate EVM of a DUT in accordance with one embodiment of the presently claimed invention.

FIG. 5 depicts signal diagrams when establishing a PER to estimate EVM of a DUT in accordance with another embodiment of the presently claimed invention.

### DETAILED DESCRIPTION

The following detailed description is of example embodiments of the presently claimed invention with references to the accompanying drawings. Such description is intended to be illustrative and not limiting with respect to the scope of the present invention. Such embodiments are described in sufficient detail to enable one of ordinary skill in the art to practice the subject invention, and it will be understood that other embodiments may be practiced with some variations without departing from the spirit or scope of the subject invention.

Throughout the present disclosure, absent a clear indication to the contrary from the context, it will be understood that individual circuit elements as described may be singular or plural in number. For example, the terms “circuit” and “circuitry” may include either a single component or a plurality of components, which are either active and/or passive and are connected or otherwise coupled together (e.g., as one or more integrated circuit chips) to provide the described function. Additionally, the term “signal” may refer to one or more currents, one or more voltages, or a data signal. Within the drawings, like or related elements will have like or related alpha, numeric or alphanumeric designators. Further, while the present invention has been discussed in the context of implementations using discrete electronic circuitry (preferably in the form of one or more integrated circuit chips), the functions of any part of such circuitry may alternatively be implemented using one or more appropriately programmed processors, depending upon the signal frequencies or data rates to be processed. Moreover, to the extent that the figures illustrate diagrams of the functional blocks of various embodiments, the functional blocks are not necessarily indicative of the division between hardware circuitry.

Wireless devices, such as cellphones, smartphones, tablets, etc., make use of standards-based technologies (e.g., IEEE 802.11a/b/g/n/ac, 3GPP LTE, and Bluetooth). The standards that underlie these technologies are designed to provide reliable wireless connectivity and/or communications. The standards prescribe physical and higher-level specifications generally designed to be energy-efficient and to minimize interference among devices using the same or other technologies that are adjacent to or share the wireless spectrum.

Tests prescribed by these standards are meant to ensure that such devices are designed to conform to the standard-prescribed specifications, and that manufactured devices continue to conform to those prescribed specifications. Most devices are transceivers, containing at least one or more receivers and transmitters. Thus, the tests are intended to confirm whether the receivers and transmitters both conform. Tests of the receiver or receivers (RX tests) of a DUT typically involve a test system (tester) sending test packets to the receiver(s) and some way of determining how the DUT receiver(s) respond to those test packets. Transmitters of a DUT are tested by having them send packets to the test system, which then evaluates the physical characteristics of the signals sent by the DUT.

System performance of a DUT is generally not affected by its EVM, though it is affected by its PER. The EVM is specified at the system level such that the transmitted signal is generally not a major contributor to the system PER. Rather, the dynamic range of the signal power being received, typically due to variations in signal path losses, will be the dominant contributor. By comparing a measured PER point to an expected PER point using a known receive signal level and the transmit signal quality is poor, the PER point will occur at a higher input signal power level, indicating that the transmit signal quality is affecting the system performance. As discussed in more detail below, there is a sufficiently accurate correlation between the 50% PER point of a system and its EVM at that power level. Using that correlation, it is possible to extrapolate a value of transit (TX) signal quality relative to the sensitivity point of the receiver of the DUT as determined during manufacturing of the DUT. This will allow making a “pass” or “fail” transmit signal quality determination without requiring the use of a sophisticated test system having the capability of data packet signal capture and VSA functionality.

Further, the test instrument can be designed with a low noise figure, thereby allowing external signal attenuation to be the major contributor to establishing signal path loss for testing purposes. This enables test measurements to be performed at lower input signal levels, and avoids a requirement for the significantly better EVM performance normally required from an EVM tester. This allows a DUT to be tested at low power signal levels where testing is important to determine when and where overall system operation begins to deteriorate.

This advantageously allows a DUT to be tested to determine transmit signal quality with large signal path losses such as those experienced in an OTA measurement testing environment. Additionally, as described in more detail below, the testing environment does not require a VSA, thereby enabling a lower cost test system.

The 50% PER point is preferably used as the typical PER curve of a DUT has its maximum slope at this point, thereby making it less sensitive to statistical variations. Further, it enables easier iterative algorithms, thereby enabling faster testing. (See, for example, U.S. patent application Ser. No. 13/959,354, entitled “Method for Testing Sensitivity of a Data Packet Signal Transceiver”). Of course, other PER points can also be used to determine the PER point where the PER is less than or greater than 50%.

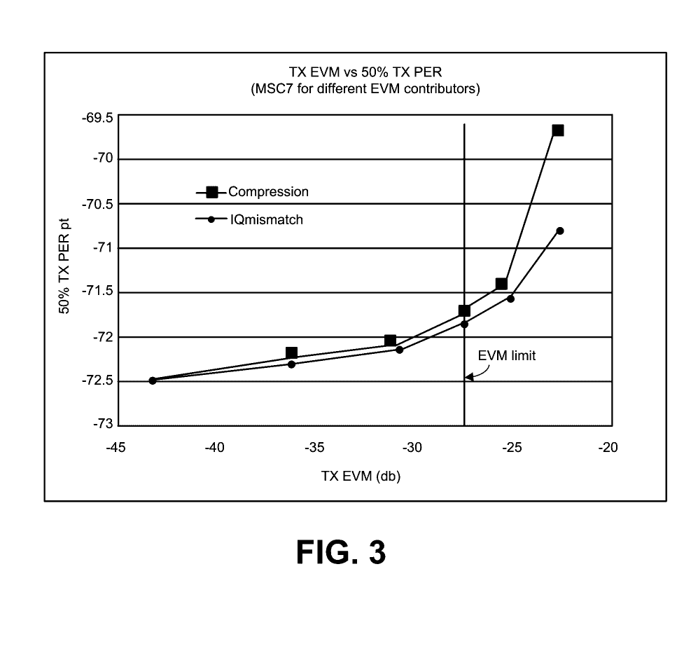

Referring to FIG. 3, the presently claimed invention advantageously capitalizes on the fact that the packet error rate (PER) and EVM of a data packet signal transceiver are typically correlated, substantially as shown. For example, current data packet signal transceivers operating in accordance with the IEEE802.11 standards will have signal power points at which the PER is 50% that are correlated with EVM values substantially as shown. For example, as shown, the power points at which the PER is 50% and EVM values are highly correlated below a typical EVM limit corresponding to the two major causes of EVM, i.e., signal compression and I/Q mismatch. Hence, if a DUT has a packet error rate of 50% at a measured input data packet signal power of −71.8 dBm, the expected EVM to be measured will be −28 dB. Similarly, input power levels of −72 dBm, −72.4 dBm and −72.5 dBm at which a DUT has a packet error rate of 50% correspond to expected measured EVM of −31 dB, −35.5 dB and −43 dB, respectively. Hence, once the input power level has been established for a 50% PER, the corresponding expected EVM value can be estimated with a high degree of accuracy. (As is common in practice, these PER versus EVM correlation points may require calibration so as to accurately account for performance variations among various DUTs.)

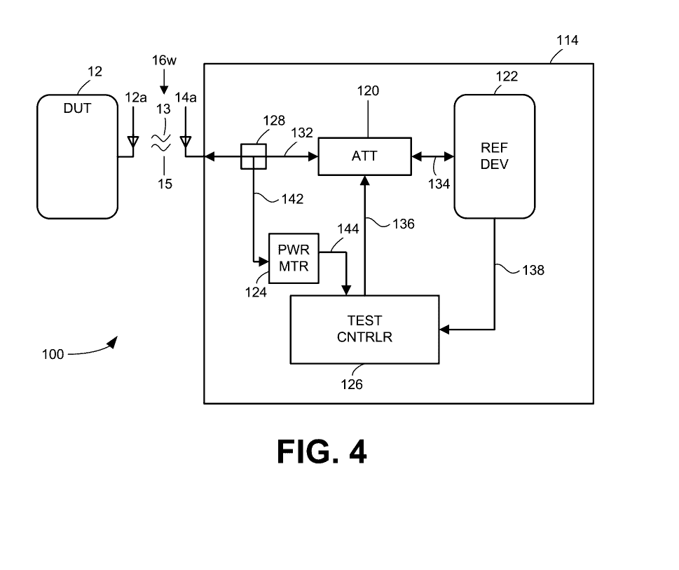

Referring to FIG. 4, in accordance with an exemplary embodiment of the presently claimed invention, the DUT 12 can be tested to estimate its EVM using a tester 114 as follows. The tester 114 includes a variable RF signal attenuator 120, a reference device 122 (e.g., a “known good device”, e.g., a device similar to the DUT 12, that has already been tested and confirmed to operate as required under the applicable standards), a power measurement device or system 124 (e.g., a RF signal power meter), a RF signal power divider or coupler 128, and a test controller 126 (e.g., a personal computer or other program logic circuitry capable of analyzing digital data and providing digital control signals), interconnected substantially as shown.

The power meter 124 measures divided or coupled RF signal 142 received from the DUT 12 via the power divider or coupler 128, and provides a measured power signal 144 to the test controller 126. The test controller 126 also receives one or more signals 138 from the reference device 122 (e.g., response data packets in the form of acknowledgment, or “ACK”, data packets), and provides one or more control signals 136 to control the RF signal attenuation of the attenuation circuitry 120. The signal attenuator 120 applies variable signal attenuation to the RF signal 132 from the DUT 12, with the resulting attenuated RF signal 134 provided to the reference device 122. Since the power meter 124 measures the incoming RF signal 132 and any remaining signal attenuation occurs downstream within the tester 114, external signal path losses are not critical. Accordingly, this testing environment and technique are well suited to OTA signal measurements in which it is often difficult to ensure accurate and repeatable signal path losses.

The DUT 12 and tester 114 communicate via a signal path 16, which, in this example embodiment, is a wireless, or radiative, signal path 16w. During signal transmission, the DUT 12 radiates the data packet signal 13 via an antenna 12a, which is received by an antenna 14a of the tester 114. Conversely, during signal reception by the DUT 12, RF signals 15 are transmitted by the tester 114 via its antenna 14a for reception by the antenna 12a of the DUT 12, in accordance with well-known principles.

As discussed above, establishing the input power level of the RF data packet signal received by the reference device 122 at which its PER is 50% is accomplished using the test controller 126, power meter 124 and attenuator 120 as follows. The power meter 124 determines the power level of the incoming DUT signal 132 received by the attenuator 120 (by allowing for the known power loss due to the power divider or coupler 128). Beginning with an initial signal attenuation level (e.g., zero or a lower attenuation level where reliable signal reception is ensured), the attenuator 120 provides the attenuated data packet signal 134 to the reference device 122. In conformance with the signal standards, the reference device 122 provides responsive data packets 138 indicative of successful reception of the incoming data packets 134. The test controller 126 compares these responsive data packets 138 to the number of incoming data packets, as determined by the signal 144 provided by the power meter 124.

If this comparison of the responsive data packets 138 to the incoming data packets 144 is greater than 50% (or some other desired PER point for testing purposes), the test controller 126 instructs the signal attenuator 120 to increase its signal attenuation. Conversely, if the number of responsive data packets 138 compared to the incoming data packets 144 is less than 50%, the test controller 126 instructs the signal attenuator 120 to decrease its signal attenuation. Alternatively, an iterative process can be used. For example, if a packet is received correctly (and thereby produces an ACK) the attenuation in increased for the next packet. After a number of iterations of attenuation increases, a statistical distribution can be applied to determine the 50% (or other) PER point (e.g., in terms of signal attenuation setting).

Once the signal level (the measured incoming signal power less the attenuation value being applied) has been determined that results in 50% of the incoming data packets 144 being received, the EVM of the DUT 12 can be estimated by comparing that resultant signal power level to a correlation graph similar to that depicted in FIG. 3.

For example, with the attenuator 120 distribution set such that a PER 50% has been established, and the measured power of the incoming data packet 132 is −52.5 dBm and the attenuator 120 is set for statistically interpolated attenuation value of 20.2 dB, then the signal being received by the reference device 122 has a power level of −72.7 dBm, thereby making the expected EVM of the DUT 12 approximately −43 dB. In other words, once a 50% PER point has been established, the measured power of the incoming DUT signal and attenuation of the signal attenuator 120 can be used to establish the power level of the signal 134 received by the reference device 122, and a correlation curve, or correlation data table, can be consulted to determine the expected EVM.

As can be seen in the curve of FIG. 3, more EVM uncertainty is expected for good EVM (low EVM transmit signals). However, as discussed above, when transmit quality is good, such EVM uncertainty has little impact on system performance. Hence, the test objective will be that of looking for bad transmit quality where the PER versus EVM curve is significantly steeper.

When testing a DUT 12 operating in a time division duplex (TDD) mode, the attenuator 120 can be programmed dynamically via the control signals 136 from the test controller 126 to apply reduced or minimum attenuation during the response (ACK) operation interval and the full desired attenuation during reception of the DUT data packets, thereby ensuring that responsive data packets from the reference device 122 are returned to the DUT 12 (via signal path 134, attenuator 120, signal path 132 and wireless signal path 16w). During normal operations, the DUT 12 will need to receive these responsive data packets, but these data packets are at lower data rates since only signals employing maximum modulation are typically tested for transmit signal quality. This results in the responsive data packets having significantly lower signal-to-noise ratio requirements, thereby ensuring that their responsive data packets should be received even if the attenuation applied by the signal attenuator 120 remains at the higher value used during transmit signal testing.

Alternatively, the test can also be performed in a special driver mode, in which the DUT 12 is only transmitting and not reliant upon reception of the responsive data packets. The reference device 122 within the tester 114 will determine if a responsive data packet is to be generated and will provide such responsive data packets 138 to the test controller. Alternatively, the signals 138 provided by the reference device 122 to the test controller 126 can be indicative of responsive data packets being generated, in which case the test controller 126 will instruct the attenuator 120 (via its control signals 136) to reduce signal attenuation applied by the attenuator 120, thereby allowing normal RF response (ACK) data packets to be transmitted by the reference device 122 for reception by the power meter 124 (via the signal divider or coupler 128), with the signal 144 from the power meter 124 informing the test controller 126 of such responsive data packets.

Systems offering more than one data rate may rate-negotiate to a lower data rate when packets are not received correctly. This is intended to maximize throughput of the system. However, lowering the data rate also reduces transmit requirements. Thus, if the data rate is lowered, the packets become easier to receive, and the input level shifts. Accordingly, it is generally more desirable that the system measures packets at the highest data rate. Returning the data rate to a higher value requires the signal path loss to be reduced. Alternatively, rate-negotiation can be prevented by ensuring that packets following a “bad” packet (that may otherwise initiate rate-negotiation) are more likely to be received (e.g., having sufficient signal power to ensure there is no statistical chance of them not being received due to noise). Such packets should not be counted as part of the PER point search.

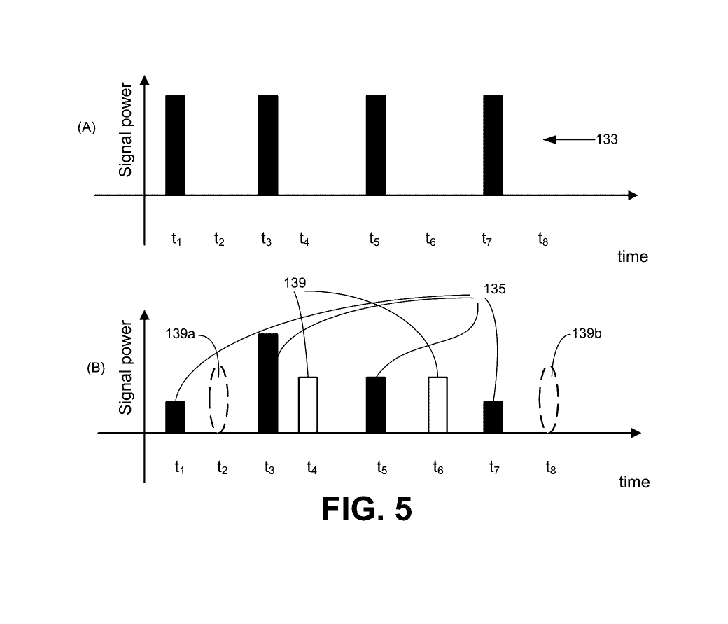

Referring to FIG. 5, establishing the desired PER point, as discussed above, can be accomplished as follows. As shown in the upper signal graph, the DUT 12 transmits data packets 133 at a substantially constant power level. These are the data packets 133 received by the signal attenuator 120. Initially, during time interval T1, the attenuated data packet 135 received via the signal path 134 by the reference device 122 is too low to be correctly received. Accordingly, during time interval T2, no responsive data packet 139a is generated. Subsequently, to avoid rate-negotiation during time interval T3, the signal attenuation of the attenuator 120 is reduced (preferably significantly) and the incoming data packet signal 133 is successfully received in its less attenuated form 135 by the reference device 122, following which, during time interval T4, a responsive data packet 139 is generated. The higher power packet of time interval T3 is not included for purposes of computing the PER.

Next, during the next time interval T5, the attenuated incoming data packets signal 135 level is determined by iterating the attenuation value to be slightly less that the attenuation value applied during time interval T1, thereby causing, during time interval T6, another responsive data packet 139 to be generated. Subsequently, during time interval T7, the still further attenuated incoming data packet signal 135 again becomes too low in power for successful reception by reference device 122, thereby resulting, during time interval T8, in no responsive data packet 139b being generated. This process can be repeated in an iterative manner to achieve the desired, e.g., 50%, PER point, with a reduced likelihood of rate-negotiation being initiated. (As will be readily appreciated by those skilled in the art, this attenuation iteration algorithm as described can be modified to include more advanced attenuation iteration techniques based upon known or learned DUT behaviors leading to or during rate-negotiation.)

Various other modifications and alterations in the structure and method of operation of this invention will be apparent to those skilled in the art without departing from the scope and the spirit of the invention. Although the invention has been described in connection with specific preferred embodiments, it should be understood that the invention as claimed should not be unduly limited to such specific embodiments. It is intended that the following claims define the scope of the present invention and that structures and methods within the scope of these claims and their equivalents be covered thereby.

What is claimed is:

1. An apparatus including a system for testing a radio frequency (RF) data packet signal transceiver device under test (DUT), comprising:
a RF signal path to convey, from a DUT, a transmit data packet signal having a transmit signal power and including a plurality of transmit data packets;
attenuation circuitry coupled to said RF signal path and responsive to one or more control signals by attenuating said transmit data packet signal to provide a corresponding attenuated data packet signal having an attenuated signal power and including said plurality of transmit data packets;
receiver circuitry coupled to said attenuation circuitry and responsive to said attenuated data packet signal by providing a reply data packet signal including a plurality of reply data packets; and
control circuitry coupled to said RF signal path, said attenuation circuitry and said receiver circuitry, and responsive to said transmit and reply data packet signals by providing said one or more control signals such that a ratio of said pluralities of reply and transmit data packets is less than a defined value.

2. The apparatus of claim 1, wherein each one of said plurality of reply data packets corresponds to a respective one of at least a portion of said plurality of transmit data packets.

3. The apparatus of claim 1, wherein said ratio of said pluralities of reply and transmit data packets comprises a packet error rate (PER).

4. The apparatus of claim 1, wherein said RF signal path comprises serially coupled wireless and conductive RF signal paths.

5. The apparatus of claim 1, wherein said attenuation circuitry comprises variable resistive circuitry.

6. The apparatus of claim 1, wherein said receiver circuitry comprises a RF data packet signal transceiver having one or more data packet signal transceiver capabilities similar to said DUT.

7. The apparatus of claim 1, wherein said control circuitry is responsive to said transmit signal power and said reply data packet signal by providing said one or more control signals.

8. The apparatus of claim 1, wherein said control circuitry is responsive to said transmit and reply data packets by providing said one or more control signals.

9. The apparatus of claim 1, wherein said control circuitry comprises power measurement circuitry.

10. The apparatus of claim 1, wherein said control circuitry comprises logic circuitry.

11. A method for testing a radio frequency (RF) data packet signal transceiver device under test (DUT), comprising:
conveying, from a DUT via a RF signal path, a transmit data packet signal having a transmit signal power and including a plurality of transmit data packets;
responding to one or more control signals by attenuating said transmit data packet signal to provide a corresponding attenuated data packet signal having an attenuated signal power and including said plurality of transmit data packets;
receiving said attenuated data packet signal and in response thereto providing a reply data packet signal including a plurality of reply data packets; and
receiving said transmit and reply data packet signals and in response thereto providing said one or more control signals such that a ratio of said pluralities of reply and transmit data packets is less than a defined value.

12. The method of claim 11, wherein each one of said plurality of reply data packets corresponds to a respective one of at least a portion of said plurality of transmit data packets.

13. The method of claim 11, wherein said ratio of said pluralities of reply and transmit data packets comprises a packet error rate (PER).

14. The method of claim 11, wherein said conveying, from a DUT via a RF signal path, a transmit data packet signal comprises conveying said transmit data packet signal via serially coupled wireless and conductive RF signal paths.

15. The method of claim 11, wherein said responding to one or more control signals by attenuating said transmit data packet signal comprises attenuating said transmit data packet signal via variable resistive circuitry.

16. The method of claim 11, wherein said receiving said attenuated data packet signal and in response thereto providing a reply data packet signal including a plurality of reply data packets comprises receiving said attenuated data packet signal and in response thereto providing a reply data packet signal with a RF data packet signal transceiver having one or more data packet signal transceiver capabilities similar to said DUT.

17. The method of claim 11, wherein said receiving said transmit and reply data packet signals and in response thereto providing said one or more control signals comprises responding to said transmit signal power and said reply data packet signal by providing said one or more control signals.

18. The method of claim 11, wherein said receiving said transmit and reply data packet signals and in response thereto providing said one or more control signals comprises responding to said transmit and reply data packets by providing said one or more control signals.

19. The method of claim 11, wherein said receiving said transmit and reply data packet signals comprises measuring a power of said transmit data packet signal.

20. The method of claim 11, wherein said receiving said transmit and reply data packet signals and in response thereto providing said one or more control signals comprises logically processing said transmit and reply data packets.
